(19) United States
(12) Patent Application Publication
(10) Pub. No.: US 2018/0281092 A1
(43) Pub. Date: Oct. 4, 2018

(54) Electrode device for electrochemical workpiece machining

(71) Applicant: Poligrat GmbH, München (DE)

(72) Inventors: Olaf Boehme, Erding (DE); Siegfried Piesslinger-Schweiger, Vaterstetten (DE)

(21) Appl. No.: 15/756,829

(22) PCT Filed: Sep. 4, 2015
(86) PCT No.: PCT/EP2015/070271

§ 371 Date: Mar. 1, 2018

(51) Int. Cl. B23H 3/02

(52) U.S. Cl. CPC B23H 3/02

(57) ABSTRACT

An electrode device for electrochemical workpiece machining, for example an electropolishing or electroplating process, comprises an electrode and a power supply cable that is connected to the electrode and has an electrical conductor and a multilayer cladding structure around the electrical conductor. In one embodiment, the cladding structure comprises a helical wire for transmitting shear forces via the power supply cable and a fabric hose fitted closely around the helical wire. The helical wire prevents any narrowing of the diameter of the fabric hose and consequently any longitudinal extension of the fabric hose, for which reason the latter can be used to transmit tensile forces via the power supply cable. Around the outside of the fabric hose, the power supply cable has an electrically insulating plastics sheath.

The invention relates to an electrode device for electrochemical workpiece machining.

Electrochemical processes such as, for example, electropolishing and electroplating are used to smooth surfaces of metal workpieces from very different technical fields and to improve the functional properties of the surfaces so treated. For that purpose, the surfaces are brought into contact with a suitable electrolyte and connected as the anode or cathode in a direct-current circuit. The direct-current circuit additionally contains a counter electrode of metal which is separated by the electrolyte from the surface to be machined and, depending on whether the surface serves as the anode or cathode, is connected as the cathode or anode.

In electropolishing, under the action of the direct current, and with a suitable composition of the electrolyte, metal is removed electrochemically from the workpiece surface connected as the anode by being dissolved in the electrolyte. In electroplating, on the other hand, metal is deposited on the workpiece surface connected as the cathode.

In order to carry out controlled machining, the cathode and anode surfaces must have a defined position relative to one another, whereby they should be arranged as parallel to one another as possible. Mutual contact of the anode and cathode surfaces is to be avoided under all circumstances in order to prevent a short-circuit, which could lead to the surfaces being damaged.

If outer surfaces of workpieces are to be electrochemically treated, this is in most cases possible by immersing the workpieces and the counter electrodes in a bath filled with electrolyte and connecting them together in a direct-current circuit. By contrast, the electrochemical machining of inner surfaces of hollow bodies by electropolishing or electroplating is generally more difficult because, due to Faraday's law, the electric current does not reach the cavities of the hollow bodies without special measures. One solution consists in inserting an electrode into the cavity in question and introducing the electrolyte required for machining into the space between the electrode and the cavity surface. The electrolyte is thereby pumped through the gap between the workpiece and the electrode in order continuously to remove the gases liberated as a result of the electrolysis and the resulting process heat and to supply fresh electrolyte.

While in the case of straight and sufficiently short cavities a rod of corresponding length can be used as the electrode, and the electrode can remain stationary in situ inside the cavity during the electrochemical treatment, this may be impractical in the case of longer cavities for reasons of manageability of the electrode and is impossible in the case of cavities that are not straight. In such cases it is possible to use a sufficiently short electrode which is connected to a flexible cable for supplying power. In order to introduce the electrode into the cavity, the procedure can be, for example, as follows: a thread, cord or the like is first introduced into the cavity from one end of the cavity and is threaded through to the opposite end of the cavity. By means of the thread or cord, the electrode and the cable attached thereto can then be pulled into the cavity. During the subsequent polishing or electroplating process, the electrode is withdrawn from the cavity again by pulling the cable. During this process, in each case only the wall region of the cavity in which the electrode is situated is treated. By pulling the electrode slowly and steadily through the pipe or other body in which the cavity is located, the entire surface of the cavity is gradually machined.

The introduction of the electrode into the cavity by means of a thread or cord is laborious and can scarcely be automated. It is completely impossible to use an aid such as a thread or cord if the cavity has only one free entrance and the entire machining operation must therefore be carried out from that one entrance. This can either be because the cavity has only a single entrance, or because a further entrance is present but is not easily accessible.

The object of the invention is to provide an electrode device by means of which the interior of a workpiece can be electrochemically machined not only but even when the cavity to be machined can be reached via only a single entrance.

In order to achieve this object, the invention provides an electrode device for electrochemical workpiece machining, comprising an electrode and a power supply cable which is connected to the electrode and has an electrical conductor and a multilayer cladding structure around the electrical conductor, wherein the cladding structure comprises a helical wire within which the electrical conductor runs. The helical wire (formed by spring wire wound along a helical line), which advantageously has a constant diameter over the length of the power supply cable, enables shear forces to be transmitted via the power supply cable and thus allows the electrode device to be inserted with the electrode in front into a cavity. The helical wire allows the electrode device to be inserted even into curved or bent cavities. The wire material of the helical wire is, for example, a stainless steel and can have a round or rectangular cross-section. In some embodiments, successive turns of the helical wire form a block, that is to say they are in contact with one another, when the power supply cable is straight. In other embodiments, successive turns of the helical wire are spaced apart from one another when the power supply cable is straight. In both cases, the transmission of shear forces via the power supply cable is possible without or at least without substantial longitudinal compression thereof.

In a further development of the invention, the cladding structure further comprises a fabric hose around the helical wire. The fabric hose can be fitted around the entire helical wire. The cross-sectional size of the fabric hose in the relaxed state can, for example, be such that the fabric hose must be radially widened in order to be able to introduce the helical wire into the fabric hose or push the fabric hose onto the helical wire. In the assembled state, the fabric hose can accordingly be fitted on the helical wire with a degree of internal stress.

In some embodiments of the invention, the fabric hose has the property that it is longitudinally extensible and, when longitudinally extended, experiences a reduction in its hose inside diameter. Because the fabric hose extends around the helical wire externally, any reduction in the diameter of the fabric hose due to the action of an external tensile force is limited by the helical wire. If the fabric hose is already fitted tightly on the helical wire in the unloaded state of the power supply cable, tensile forces can be transmitted via the fabric hose without longitudinal extension of the helical wire and consequently without longitudinal extension of the power supply cable as a whole, because the helical wire prevents any reduction in the diameter of the fabric hose. Accordingly, the pairing of the helical wire and the fabric hose allows both shear forces and tensile forces to be transmitted via the power supply cable.

The fabric hose is made, for example, of thread material of tungsten.

The electrical conductor can be received loosely within the helical wire, loosely meaning that it does not completely fill the cross-sectional space within the helical wire and is not squashed or clamped by the helical wire. Shear and tensile loads on the power supply cable can thus be kept away from the electrical conductor and carried away primarily or even exclusively via the cladding structure.

The electrical conductor can be single-wire or multi-wire, copper, for example, being suitable as the conductor material owing to its high conductivity.

Advantageously, the cladding structure further comprises an outer sheath of an electrically insulating plastics material. The materials polypropylene, polyethylene, polyvinyl chloride and polyvinylidene fluoride, for example, are suitable for minimizing friction with the cavity walls of the cavity to be machined. The outer sheath can be formed, for example, by a heat-shrink tube which is shrunk onto the fabric hose by heating.

The electrode can be in the form of a rod electrode, for example, and can be formed by a solid or internally hollow rod material which is electrically connected to the electrical conductor of the power supply cable. For a shear- and tensile-force-transmitting connection between the electrode and the power supply cable, one or more layers of the cladding structure are in a preferred embodiment connected to the electrode by clamping or/and by a soldered or welded connection.

The invention further provides a method for electrochemically machining an inner surface of an electrically conducting workpiece that delimits an elongate cavity, in particular a cavity that is not straight, wherein in the method an electrode device of the type mentioned above is inserted with the electrode in front into the cavity, an electrolyte is introduced into the cavity, the electrode device is energized, and the energized electrode device is withdrawn contrary to the insertion direction from the cavity flushed with electrolyte.

The invention is explained further with reference to the accompanying drawings, in which:

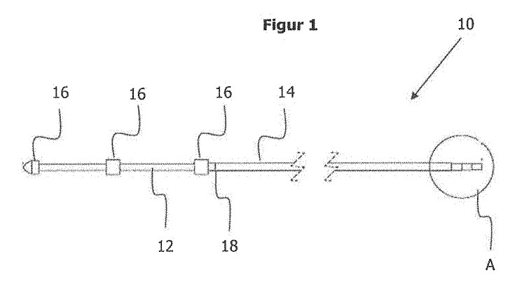

FIG. 1 shows an electrode device according to one exemplary embodiment,

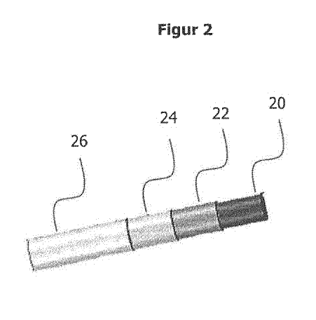

FIG. 2 shows, in schematic form and on an enlarged scale, a portion A of the electrode device of FIG. 1,

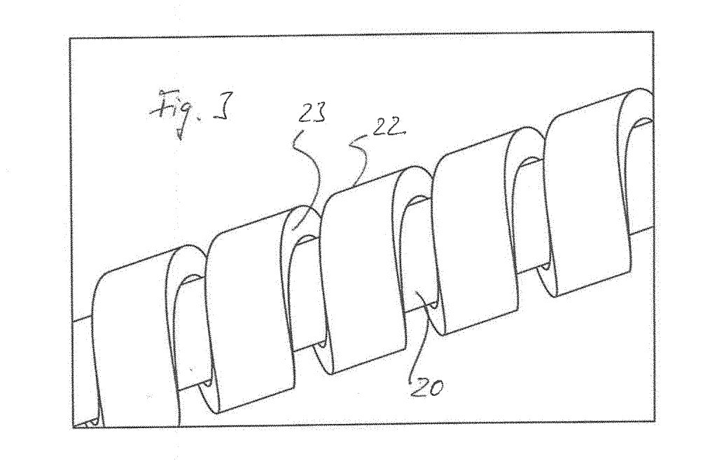

FIG. 3 is a detail view of a helical wire of the electrode device of FIG. 1,

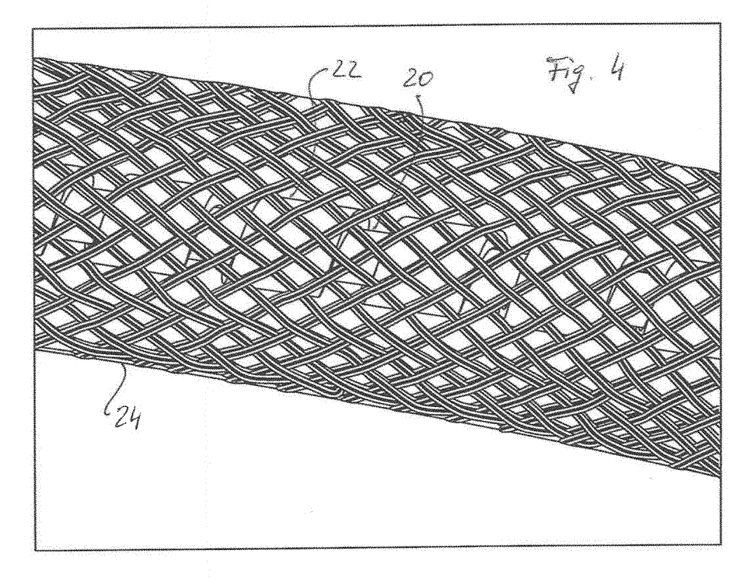

FIG. 4 is a detail view of a fabric hose of the electrode device, and

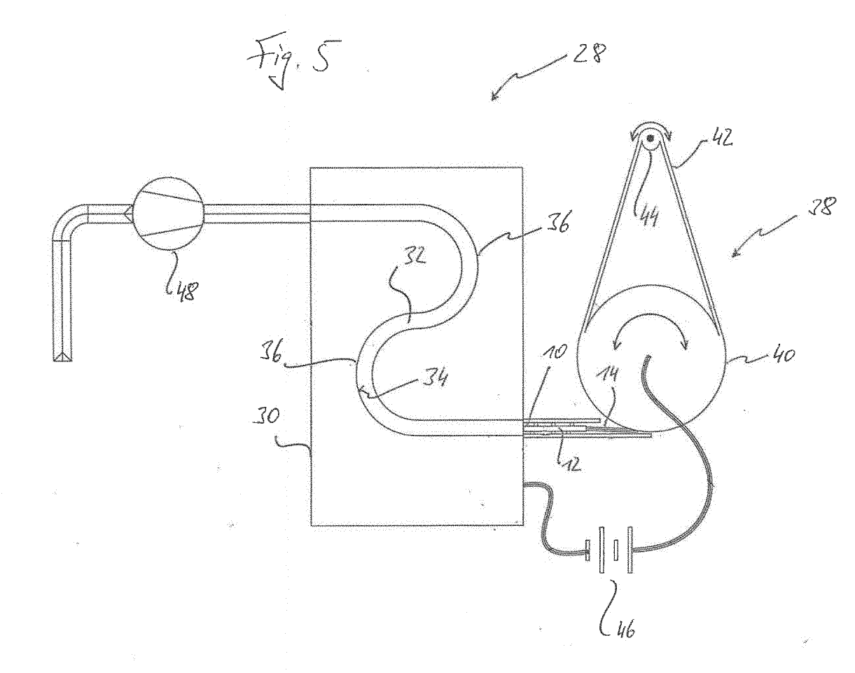

FIG. 5 shows, in schematic form, components of a system for electrochemical surface machining of a hollow channel of a metal workpiece according to an exemplary embodiment.

The electrode device shown in schematic form in FIG. 1 is generally designated 10. It comprises an electrode 12 and a flexible power supply cable 14 for supplying electric current to the electrode 12. The electrode 12 is in the form of a rod electrode, for example, whereby it can be formed from a solid or internally hollow copper rod. Electrically conductive metals other than copper are of course likewise conceivable for the electrode 12. The electrode 12, which is otherwise free of insulation, is equipped with a plurality of spacers 16 (three in the example shown) made of an electrically insulating plastics or ceramics material. The spacers 16 are advantageously fixed to the electrode 12 and can have a cross-sectional shape which is matched to the cross-sectional shape of the cavity into which the electrode device 10 is to be inserted for the purpose of electrochemical machining of the cavity walls. While the right-hand and middle spacers of the total of three spacers 16 shown in FIG. 1 enclose the electrode 12 annularly, the left-hand spacer 16 in FIG. 1 is fitted to the free end of the electrode 12, where it forms an end cap. The spacers 16 serve to hold the electrode 12 at a defined distance on all sides from the cavity walls that are to be machined when the electrode 12 is introduced into the cavity. The cavity is, for example, the interior of a straight or non-straight pipe, the inside of a bore, or any other channel which is formed in a metal workpiece and the wall of which is to be machined by electropolishing or electroplating.

In the example shown in FIG. 1, the electrode 12 extends from the left-hand spacer to just beyond the right-hand spacer of the three spacers 16 shown and can have a length in the region of a few centimeters, for example. For example, the length of the electrode 12 is not more than 6 cm or not more than 5 cm or not more than 4 cm.

The power supply cable 14 is connected to the electrode 12 at a connection point indicated schematically at 18, both electrically and in such a manner as to transmit shear and tensile forces. The length of the power supply cable is sufficiently great to insert the electrode 12 into the deepest regions of the cavity to be machined. For example, the power supply cable is several 10 cm long or has a length in the region of meters. The power supply cable 14 is—although not shown in FIG. 1—wound onto a roll and is unwound from the roll as it is inserted into the cavity to be machined. The mentioned roller is motor-driven, for example, so that motorized insertion of the electrode device into the cavity to be machined and—by reversing the direction of rotation of the motor—motorized withdrawal of the cable is possible.

The power supply cable 14 consists of a plurality of layers which surround one another coaxially. The innermost layer is formed by an electrical conductor 20, which is formed, for example, by a plurality of copper wires twisted together. The diameter of the electrical conductor 20 can be, for example, in a range of from approximately 0.2 mm to approximately 2 mm. In the case of a multi-wire form, the number of wires can be, for example, between 10 and 25. As an example, the electrical conductor 20 can consist of a strand of 18 single wires having a single wire diameter of approximately 0.1 mm. Alternatively, the electrical conductor 20 can be formed by a single wire having a wire diameter of, for example, approximately 1 mm.

As the next layer, the power supply cable 14 has a helical wire 22. FIG. 3 shows an example of a configuration of the helical wire 22 (with the electrical conductor 20 running therein) in an enlarged view. In the example shown in FIG. 3, the helical wire 22 is formed by a helically wound spring wire 23 of rectangular cross-section. The helical wire 22 has, for example, a spiral diameter of between approximately 1 mm and approximately 3 mm. The thickness of the spring wire 23 is, for example, in a range between approximately 0.1 mm and approximately 0.5 mm. In the example shown in FIG. 3, the longer rectangle side of the four-edged cross-section of the spring wire 23 is oriented in the longitudinal direction of the helical wire 22, while the shorter rectangle side of the wire cross-section is transverse thereto. For example, the four-edged spring wire 23 shown in FIG. 3 has a cross-sectional dimension of approximately 0.5 mm×0.25 mm. In a specific exemplary embodiment, the helical wire 22 can have a spiral diameter of, for example, approximately 1.8 mm.

In FIG. 3, the successive turns of the helical wire 22 are shown spaced apart from one another, the spacing being substantially smaller than the width of the spring wire 23 measured in the longitudinal direction of the helical wire and being less than half the wire width in the example shown. This mutual spacing between the successive turns can be present in the relaxed state of the helical wire 22. In other forms, however, it Is also possible that, in the relaxed state of the helical wire 22, the successive turns of the helical wire 22 form a block, that is to say are in contact with one another without a mutual spacing. If the turns of the helical wire 22 are spaced apart from one another in the rest state of the wire, the spacing is preferably so small that no or no substantial longitudinal compression of the helical wire 22 is to be expected under the expected shear loads. In the case of a configuration in which the turns of the helical wire 22 already form a block in the rest state, such longitudinal compression under shear loading is in any case ruled out. If the turns of the helical wire 22 are mutually spaced apart in the relaxed and unbent state, the turns can be pushed together on the inside of the curves when the power supply cable 14 is pushed or pulled through a channel having one or more curves, while they can move apart on the outside of the curves. That is to say, the helical wire 22 is compressed on the inside of the curve as it passes a curve, while it is stretched on the outside of the curve. This makes it possible to treat channels or other cavities with comparatively tight curves, that is say small curve radii.

The electrical conductor 20 runs radially in the helical wire 22 without being clamped, so that it is able to move in the longitudinal direction relative to the helical wire 22 without substantial resistance. This allows the electrical conductor 20 to be held as far as possible without longitudinal forces, which can act on the helical wire 22. FIG. 3 illustrates that the electrical conductor 20 is free of radial clamping by showing a certain radial spacing between the inside of the spring wire 23 and the electrical conductor 20.

As is shown in FIG. 2, the helical wire 22 is enclosed radially outwardly by a fabric hose 24, the fabric threads of which extend at least partially at an angle relative to the cable longitudinal direction, so that a longitudinal extension of the fabric hose 24 is accompanied by a reduction in the diameter of the fabric hose 24. The fabric hose 24 is fitted tightly on the helical wire 22, so that a reduction in the diameter of the fabric hose 24 is not—or if at all—only scarcely possible. Because of its inability, or at least greatly limited ability, to become narrower, the fabric hose 24 is able to transmit tensile forces without expanding longitudinally. In conjunction with the helical wire 22, which imparts shear rigidity to the power supply cable 14, both tensile and shear forces can thus be transmitted via the power supply cable 14, even when the cable 14 follows any curves or bends in the cavity to be machined and is correspondingly bent.

An enlarged view of the fabric hose 24 is shown in FIG. 4. It will be seen that the fabric hose 24 is formed of two interwoven thread systems each running at an angle relative to the cable longitudinal direction. The two thread systems are both formed of the same type of thread, for example of tungsten threads. The fabric hose 24 has, for example, a thread thickness of the fabric thread used for the fabric of between approximately 0.03 mm and approximately 0.125 mm. The diameter of the fabric hose 24 in the relaxed state is, for example, between approximately 1 mm and approximately 3 mm. In a specific exemplary embodiment, the fabric hose 24 in the relaxed state can have a diameter of, for example, approximately 2.1 mm with a thread thickness of approximately 0.05 mm.

In addition, it should be pointed out that the electrical conductor 20 and the helical wire 22 are also shown in FIG. 4 in addition to the fabric hose 24, but the relative proportions shown between the fabric hose 24 on the one hand and the electrical conductor 20 and the helical wire 22 on the other hand do not reflect the actual proportions in the finished power supply cable 14. It has already been mentioned that, in the power supply cable 14, the fabric hose 24 is fitted tightly on the helical wire 22, that is to say surrounds it closely. Compared to these proportions in the finished power supply cable 14, FIG. 4 shows the fabric hose 24 with an enlarged diameter, the fabric hose 24 surrounding the helical wire 22 only loosely, that is to say with radial spacing.

The outermost layer of the power supply cable 14, which in the example shown is composed of four layers, is formed by an outer sheath 26 which is produced from an electrically insulating and comparatively low-friction plastics material and which is applied to the fabric hose 24 by heat shrinking. Examples of plastics materials for the outer sheath 26 are PP (polypropylene), PE (polyethylene), PVC (polyvinyl chloride) and PVDF (polyvinylidene fluoride).

The electrode device 10 can be moved in a controlled manner through pipes or channels inside metal workpieces both by pushing and by pulling, even if the electrode device thereby comes up against a number of bends or longer curves. Accordingly, the electrode device 10 can be used to electropolish or electroplate even pipes or channels that are accessible from only one end, since an auxiliary cord is not required for inserting the electrode device 10 into the pipe or channel.

FIG. 5 shows, in schematic form, an exemplary embodiment of a system 28 for electroplating or electropolishing the inner surface of a hollow channel 32 formed in a metal workpiece 30. The inner surface of the hollow channel 32 is designated 34. It will be seen that the hollow channel 32 in the workpiece 30 is not straight but has a number of curves or bends 36. The system 28 comprises a winding device 38 for the power supply cable 14 of the electrode device 10. The winding device 38 comprises a cable roll 40, which in the example shown is in drive connection via a belt 42 with a drive roller 44. The drive roller 44 is in turn coupled with an electromotive drive unit (not shown) and can be driven in both directions of rotation by this drive unit. By means of the winding device, the power supply cable 14 can accordingly be wound onto the cable roll 40 and unwound therefrom.

For machining of the hollow channel 32, the electrode device 10 is first inserted, with the electrode 12 in front, into the hollow channel 32 from one end of the channel and while being continuously unwound from the cable roller 40, for example until the electrode 12 has reached the opposite end of the channel. At the end of the cable remote from the electrode 12, the electrical conductor 20 of the power supply cable 14 is connected to one terminal of a DC voltage source 46, to the other terminal of which the workpiece 30 is connected. The gap between the electrode 12 and the inner surface 34 of the hollow channel 32 is filled with an electrolyte and flushed. For that purpose, the system 28 has a pumping mechanism 48, by means of which the electrolyte can be introduced into the hollow channel 32 from one end of the channel (in the example shown in FIG. 5, from the left-hand end of the channel). The electrolyte can leave at the other end of the channel and be caught, for example, in a collecting tray (not shown).

While the hollow channel 32 is being flushed with the electrolyte, the electrode 12 is withdrawn through the hollow channel 32, the power supply cable 14 continuously being wound up. The inner surface 34 of the hollow channel 32 is thereby electropolished or electroplated according to the direction of polarity of the DC voltage source 46 and according to the nature of the electrolyte.

1. An electrode device for electrochemical workpiece machining, comprising:
an electrode,
a power supply cable which is connected to the electrode and has an electrical conductor and a multilayer cladding structure around the electrical conductor, wherein the cladding structure comprises a helical wire within which the electrical conductor runs.

2. The electrode device as claimed in claim 1, wherein successive turns of the helical wire form a block or are spaced apart from one another when the power supply cable is straight.

3. The electrode device as claimed in claim 1, wherein the helical wire has a round cross-section or a rectangular cross-section.

4. The electrode device as claimed in claim 1, wherein the cladding structure further comprises a fabric hose around the helical wire.

5. The electrode device as claimed in claim 4, wherein the fabric hose is fitted around the entire helical wire.

6. The electrode device as claimed in claim 4, wherein the fabric hose is longitudinally extensible and, when longitudinally extended, experiences a reduction in its hose inside diameter.

7. The electrode device as claimed claim 4, wherein the fabric hose is made of thread material of tungsten.

8. The electrode device as claimed in claim 1, wherein the electrical conductor is received loosely within the helical wire.

9. The electrode device as claimed in claim 1, wherein the electrical conductor is in multi-wire form.

10. The electrode device as claimed in claim 1, wherein the electrical conductor comprises one or more copper wires.

11. The electrode device as claimed in claim 1, wherein the cladding structure further comprises an outer sheath of an electrically insulating plastics material.

12. The electrode device as claimed in claim 11, wherein the plastics material comprises at least one of polypropylene, polyethylene, polyvinyl chloride and polyvinylidene fluoride.

13. The electrode device as claimed in claim 4, wherein the outer sheath is shrunk onto the fabric hose.

14. The electrode device as claimed in claim 1, wherein the electrode is in the form of a rod electrode.

15. The electrode device as claimed in claim 1, wherein one or more layers of the cladding structure are connected to the electrode by clamping or/and by a soldered or welded connection.

16. A method for electrochemically machining an inner surface of an electrically conducting workpiece that delimits an elongate cavity, the method comprising:
providing an electrode device, the electrode device comprising an electrode and a power supply cable which is connected to the electrode and has an electrical conductor and a multilayer cladding structure around the electrical conductor, wherein the cladding structure comprises a helical wire within which the electrical conductor runs;
inserting the electrode device with the electrode in front into the cavity;
introducing an electrolyte into the cavity;
energizing the electrode device; and
withdrawing the energized electrode device contrary to the insertion direction from the cavity flushed with electrolyte.
